(19) United States
(12) Patent Application Publication
(10) Pub. No.: US 2009/0024599 A1
(43) Pub. Date: Jan. 22, 2009

(54) METHOD FOR MULTI-LINGUAL SEARCH AND DATA MINING

(76) Inventor: Giovanni Tata, Provo, UT (US)

Correspondence Address: UTAH VALLEY PATENT SERVICES, LLC, 846 S. 1350 E., PROVO, UT, 84606, US

(21) Appl. No.: 12/174,678

(22) Filed: Jul. 17, 2008

Related U.S. Application Data
(60) Provisional application No. 60/961,136, filed on Jul. 19, 2007.

(51) Int. Cl. G06F 17/30

(52) U.S. Cl. 707/4; 707/E17.136; 707/E17.108

(57) ABSTRACT

A system and method for performing a search and retrieval of documents in a computer network is presented, wherein the user can conduct a multi-lingual search and receive results in his or her natural language. The system includes steps wherein a user inputs a query in a source language, and selects one or more target languages. The query is then translated into the target languages and a contextual search is performed using the original and translated queries. Once search results are obtained, a language translator utility then identifies the language of the search result and that result is then properly translated into the language of the user. This system is particularly useful for searches over the Internet.

### RELATED APPLICATIONS

This application claims priority to U.S. Provisional Application 60/961,136 entitled “METHOD FOR MULTI-LINGUAL SEARCH AND DATA MINING” which was filed on 19 Jul. 2007 for Giovanni Tata. The aforementioned application is incorporated herein by reference.

### FIELD OF INVENTION

The present disclosure relates generally to a method and system for searching and viewing multilingual information.

### BACKGROUND AND RELATED ART

The World Wide Web (“Web”) has fast become a main source of knowledge and information for many people throughout the world. The content available online is quickly expanding and evolving. As a result of the incredible amount of information available, there is a growing need for quick and efficient searching tools. Today, many search tools are available to Web users. While many of them operate differently, the end goal is the same—to provide the user with the most relevant information based on the content provided for the search.

The searching tools available to Web users differ primarily in how the searching task is carried out; however, they are all limited by the inputted query of the user. Modern day search engines are greatly impaired in their ability to deal with searches that cross multi-lingual boundaries. These searching tools have become useful and continue to improve their efficiency in searches that are English-language based, search English-language sites on the Web, and return results of English-language websites and documents. The same holds true for a German-language search, or a Spanish-language search, wherein decent search results can be found for websites and documents that match the initial language. Although the non-English searches can be fruitful, they often do not return the same number of documents or results as an all-English search would, because there is estimated to be as much as 75% of the Internet user population who speak English, and the architecture of the Web reflects this fact in that most of the content online is catered to English speakers.

Thus, while the content on the Web continues to expand, it is segmented and is not truly available to all users due to language barriers. There is an increasing need to have the ability to effectively search the Web for documents and information that don't necessarily match the user's native language. There is, therefore, a need to improve searching techniques to allow for effective searching in more than one language.

Yet another drawback to the Internet being English-oriented is that the content is not fully available or useful to a non-English speaker. This problem, again, could be overcome with an effective method of searching in more than one language.

### SUMMARY OF INVENTION

A need, therefore, exists for a method of searching that functions well in a multi-lingual environment, wherein searches can be conducted in multiple languages and results can be received and properly translated to be of use to a user. The method outlined herein provides for such a method for performing a search and retrieval of documents in a computer network that reaches across language barriers, particularly where the network is the Internet or World Wide Web.

In one of many possible embodiments, a user inputs a query in his or her natural (i.e. source) language and selects one or more target languages. The query can then be translated into each target language and a contextual search can be conducted with each translated query. Once search results are received, the language of the individual results can be determined and they can then be properly translated into the source language of the user.

In variations on this example embodiment, a simultaneous search can be conducted in the user's source language. In yet another variation, this method can be applied to internet searches for both English speakers and non-English speakers, thus greatly enlarging the breadth and scope of online searches. Ultimately, this can allow a user to expand searching abilities to encompass much more of the Web than was previously possible.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 is a schematic representation of an embodiment of the broad overview of the system for conducting a search and retrieval of multilingual documents.

FIG. 2 is a schematic representation of an embodiment of the general system for conducting a search and retrieval of multilingual documents, wherein the flow of information is presented as cyclic and also wherein only the translated search is used in searching.

FIG. 3 is a schematic representation of a more comprehensive outline of the steps involved in an embodiment of the system for conducting a search and retrieval of multilingual documents.

FIG. 4 is a schematic representation of one embodiment of the system, wherein both the original user query, in the initial language, and the translated queries are used to search.

FIG. 5 is a schematic representation of an example use of one embodiment of the system, wherein the user's natural language is German, and he is able to search the internet in English, French, Italian and German.

Throughout the drawings, identical reference numbers designate similar, but not necessarily identical, elements.

### DETAILED DESCRIPTION

Because there is a definite need to conduct efficient multi-lingual searches, pairing a translation system with a searching tool is a necessary step. Generally, when companies or users register their websites with search engines, they indicate the language of the content. However, a sizeable portion of the content on the Internet is not registered with search engines. A search engine combined with just a translator may be able to adequately search and retrieve information if all pages were registered correctly and contained only one language. However, this is not the case, and many pages are not registered and/or contain multiple languages. Therefore, when the results of a search are brought back for translation, they cannot be translated because the translation tool does not recognize the source language.

There is a need, therefore, to include another step in the process: a language identification step. The combination search engine—translation tool—language identifier system would allow a user to conduct useful searches across language barriers. The language identification step would be used to initially identify the results of a search and identify the source languageus) to both the translation tool and to the user. Such a system can be capable of standardizing the query or phrase input by the user to a commonly known word and then translating the same into one or more target languages prior to a search for sites that satisfy the search criteria. The system can then be capable of inputting the translated keyword into a search engine of the target language to yield search results. Further, for convenience of the user, the system may also be capable of identifying the results according to the language each result and translating the results obtained into the language of the user. Such translation can be user-defined, e.g. the user selects text and activates a translating function, or the translation can be automated, thus requiring little to no user assistance or direction.

Such a system can help a user to transcend language barriers while making a search through any system, including the Web. Such a system also obviates the need to manually and unsystematically find out the translated equivalent of a word in another language prior to conducting a search in that language.

Such a system will go a long way in transcending all language barriers and improving inter-human communication, education, and relations. This will not only pave the way for healthier interactive environment and cultural exchange but can also help in an optimal utilization of available resources on the Web.

The present invention is such a combination and is directed towards a method and system for conducting data mining and retrieval, wherein the searches are multi-lingual in nature. The following description relies on the example of a standard-type internet search. The principles of the present invention, however, are not limited to this application only. Other data mining and retrieval, no matter the system conducted in, can benefit from the principles and methodologies laid out herein. It will therefore be understood that, in light of the present disclosure, the searching methods disclosed herein can successfully be used in connection with other systems and databases. For ease of explanation, however, most examples and embodiments will be directed to the Web application, with the understanding that it is equally applicable to any multi-lingual system and/or database.

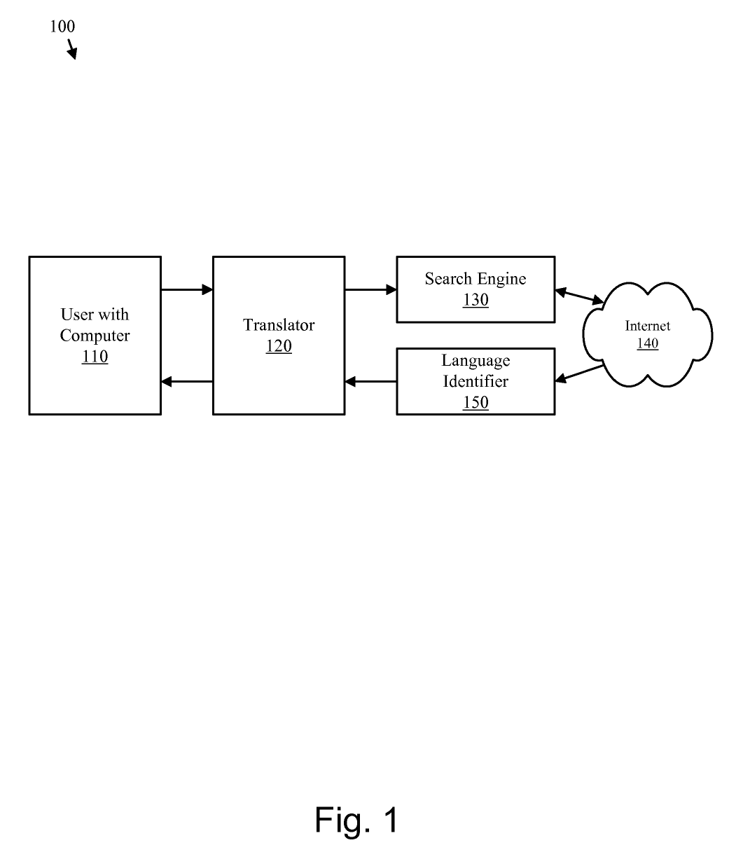

As shown in FIG. 1, a typical information search is generally composed of a user using a computer, 110. The user/computer combination, 110, can be of any nationality and rely on any primary language with a written language. The only requirement for the user is that he or she has a wish to expand data searching beyond one primary language. The computer sends information to a translator, 120. From there, the translated, and possibly the original information, can be sent to a search engine, 130. The search engine, 130, in most applications of the present invention, can interact with the internet, 140, in searching out data. The internet, 140, is not a critical element to this system; rather it is an example of a system that one can use to conduct searches. From the internet, 140, or any other searchable collection, information can be sent back to the search engine, 130, in the form of results. Those results, then, can be sent to a language identifier, 150. The language identifier, 150, can examine each result and identify the language of the text. In cases where the result is in multiple languages, the language identifier, 150, may be designed to identify some, most, or all of the languages used, rather than just the main language of the text. The language identifier, 150, can then send both the result and the identified language(s) to the translator, 120. The translator, 120, can then translate the text into the language of the user and can further send the translated results to the user with computer, 110. This outlines the broad methodology of the process wherein one can conduct data mining and retrieval in more than one language.

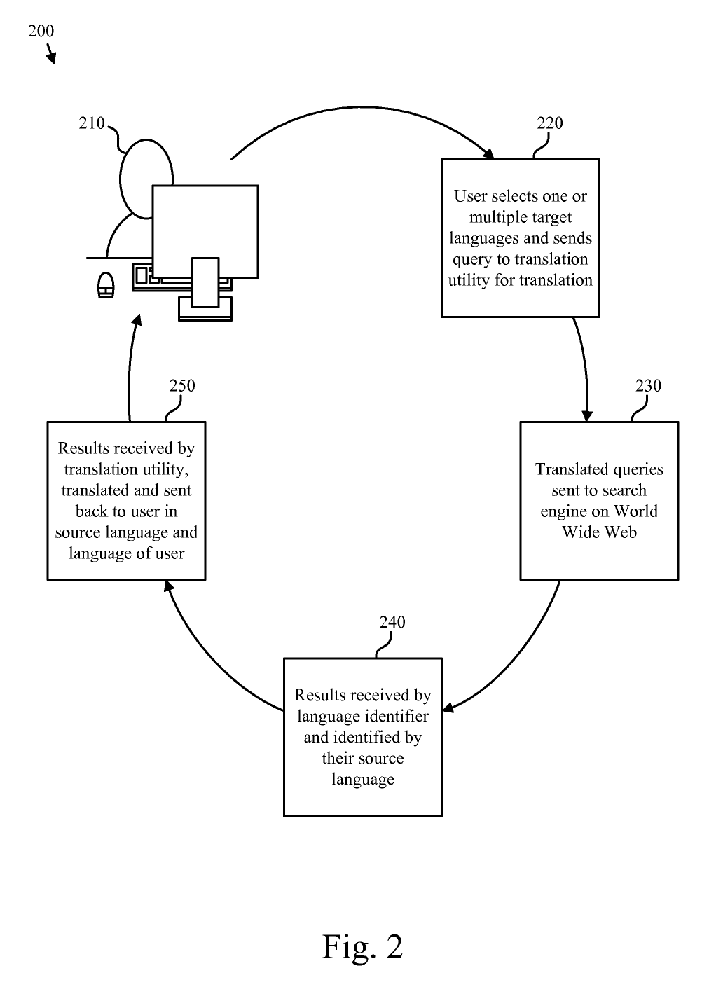

FIG. 2 shows a representation of one embodiment wherein the process is viewed as a circular path in that the user, working with a computer, 210, is able to search for data in a language different from the language the user uses to input the query. In this process, the user, with computer, 210, selects one or more target languages and enters a query. The query is the aim of the search—information that the user is looking for. Queries can consist of one word or a phrase or more information. The query can be sent to the translation utility and can be translated 220 into the target language(s). From there, the translated query, or multiple queries in the case of more than one target language, can be sent 230 to a search engine.

From the search engine, results can be received and sent individually 240 to a language identifier. The language identifier can identify the language(s) of the text. Subsequently the results, along with their identified language, are sent 250 to the translation utility for translation into the user's language. The translated results can then be sent back to the user, 10. The results may be partially translated—in that only the first line or two are translated and included in the results, or they may be fully translated, or they may include only the translated title. Results may be displayed in both the original and the source language. Further, the amount and/or portions to be translated can be selected by the user in an additional step.

Once the user receives results, additional searches may be performed, thus continuing through the cyclic process an undetermined number of times.

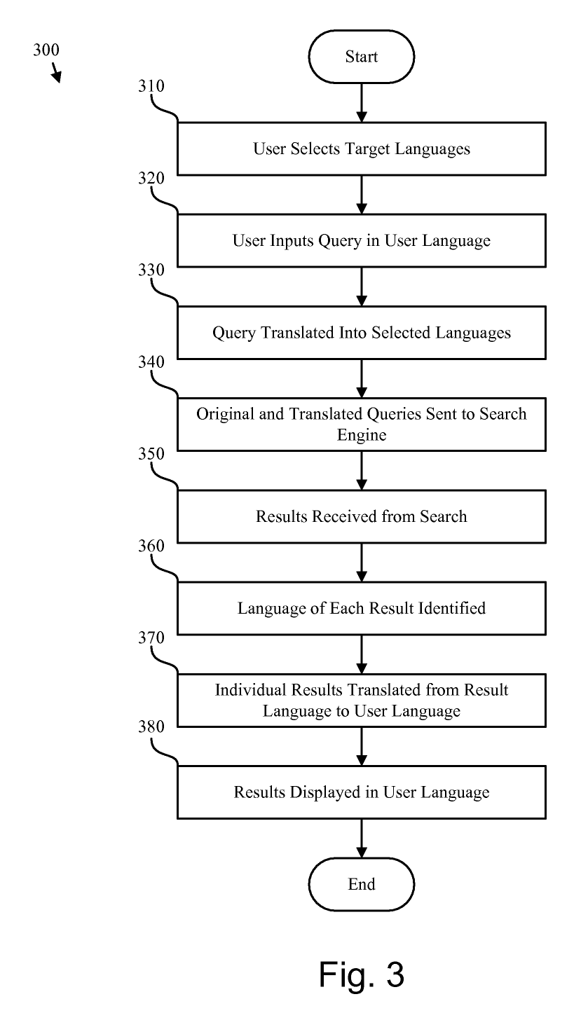

FIG. 3 shows a more comprehensive outline of the process. The user selects 310 the target language(s). The target language(s) may be one or may be more than one. The limit to the number of permissible target languages is not determined by the process or system, but is rather a function of the translation utility, and is therefore variable according to what translation utility is employed. Additionally, the target language or languages may be pre-set through the user station or the program used. In one embodiment, the number of target languages can be one. In another embodiment, the number of target languages can be greater than 2, greater than 4, greater than 8, greater than 15, greater than 20, and even greater than 40.

In the next step, the user inputs 320 a query in the source language. The source language can be used to indicate the language used by the user in formulating the initial query. The steps of 320 and 310 may be interchanged in that the user may enter a query and then select target languages.

Once the query is entered and at least one target language is selected, the query can be sent 330 to the translation utility for translation into the selected target languages. These translated queries, and the original query, can be sent 340 to a search engine. The particular search engine used is not necessarily relevant for the outline of the process, but may be relevant in particular application. There are many options of search engines that provide searching using various techniques and may supply different results. As such, the program that uses these steps may also include a step to allow the user to select various search engines to be used, or the program may rely on default search engines. Note also, that search engine in step 340 can indicate more than one search engine. It is fathomable that particular language-specific search engines may be preferable in some searching and as such multiple search engines would be advisable. If more than one search engine is used, then it may be advisable further to include a filter to remove duplicate results during a step that is prior to showing results to the user, and preferably prior to the translation step.

The search engine can send results back—as noted in 350. Those results can be sent individually to a language identifier utility where the language of each result is identified 360. In some cases, more than one language may be used on a page. Ideally, the main language of the page will be identified initially and then other languages may also be identified. In one aspect, the language identifier utility should not rely on the page's registry as some pages identify their language. This information, however, may be referenced and checked. Rather, the language identifier should rely on the text of the page to determine the language of the information.

The individual results can be then sent 370 to a translation utility for translation (referencing the language identified in 310) back into the source language of the user. There are various translation options regarding the amount content to translate and provide to the user. Options range from entire documents and websites to title and/or a couple of lines of text. The amount translated and shown to the user is a function of the set-up of the program and it should be understood that this process is not limited by the amount of content translated.

Finally, the results can be sent 380 to the user. The results may include the translated portion, the original document, links to the document, links to the website, the identified language, other languages identified on the document, and/or any other information so desired about the result.

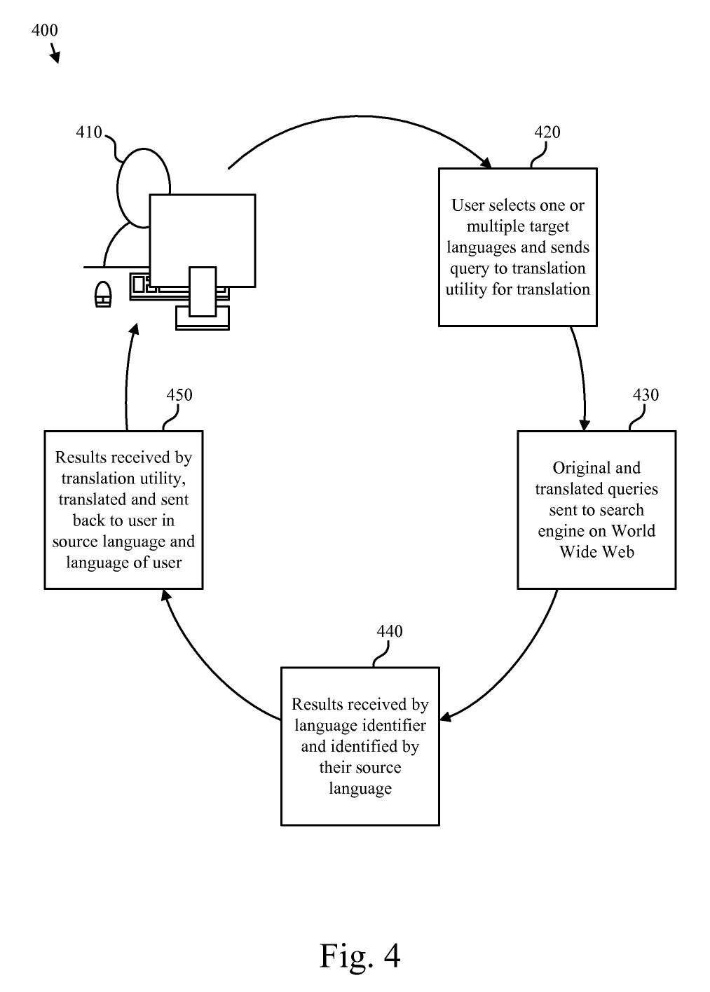

FIG. 4 is a schematic representation of the process, again shown in a cyclic manner, wherein the original query is submitted to a search along with the translated queries. Again, a user with a computer submits 410 a query and can select 420 one or more target languages. Here, the original and translated queries are sent 430 to at least one search engine on the Web. This embodiment also illustrates searching on the internet, although that is not necessarily related to the choice to search also simultaneously in the source language.

The results can be received by the language identifier and can be identified by their respective language(s) in step 440. The results can then be sent to a translation utility, and can be translated 450 into the user's source language and then can be sent back 410 to the user.

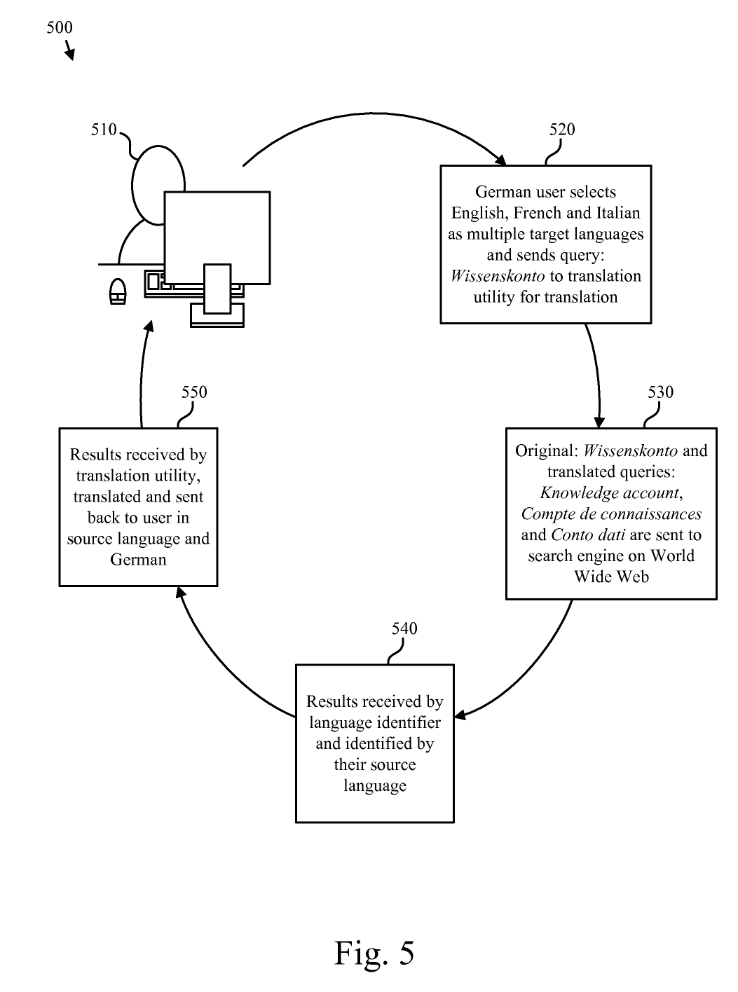

FIG. 5 follows a specific example, wherein the user, 510, is German-speaking and searching a particular topic on the Web. The user selects 520 English, French, and Italian as target languages and enters the query: Wissenskonto. In step 530, the query is translated into Knowledge account (english), Compte de connaissances (French), and Conto dat (Italian). Those translated queries along with the original query are also sent in step 530 to a search engine on the Web. The results of the search are received and sent to a language identifier and identified 540 by their respective languages. That information along with the results are then sent to a translation utility, translated, and sent back 550 to the user in German.

There have been many preferred embodiments presented, and yet many more embodiments are contemplated that are equally desirable. Examples include: allowing a user to check the translated query prior to submission to search engines; allowing a user to complete advanced searches (i.e. Boolean type); allowing a user to select among a variety of translation tools; and, allowing a user to select results for full or additional translation from the results presentation. The set-up and functionality, the availability and even the automation of the process can be use-specific. In one anticipated embodiment, the process can be fully automated, requiring minimal input from a user, e.g. target search.

To further explain the present invention, the following examples, using present technologies, are presented:

Example of the Original Design Process for the Web:

In 1994 Transoft International® introduced Network Translator® a computer program which offered translation between spoken languages on a network such as the Internet. Network Translator™ was the first translation product that combined the power of professional translation tools with vertical market dictionaries. In 1995 Transoft International® further introduced G.I.S.T. Global Internet System Translations®. This system, as with many others introduced on the market merely created an illusion of multilingual search and information retrieval. What these systems offered in effect were machine translation services. Machine translation services are services that provide a literal translation of the words queried by users. Such translations are in some cases found to be unintelligible and incomprehensible and as a result fall short of fulfilling any meaningful objective of users.

In 1997 Lexinet®, a division of Transoft International®, introduced Lexitrieve® which transforms a query input by the user in the native or source language into a resulting or target language and provide as many translations as possible in the target language. The idea is to have such a transformed query ready for use in any of the available information retrieval systems.

These tools were useful, as with others at the time, however, this system alone fails to placate the long standing need for a one stop shop which can intelligently translate a query and intelligently manage results and present them to the user in a useful manner. Thus, a language identification step is essential to the process.

Example of Anticipated Process Using Existing Technology

To begin a search, a user selects one or multiple target languages in which to perform the search. The user then inputs a query in the source language. The query is then received by a translation and search engine, Lexitrieve®. Lexitrieve®, a product of Transoft International®, utilizes the knowledge that has been accumulated from over 1000 comprehensive terminology dictionaries that span many industries. These language dictionaries allow for accurate translations of a search query into the specified target language(s). The translated query is then sent out to one or multiple search engines selected by the user, for example Google and Yahoo. The results from both searches in this case are received by a server utility that has the ability to identify the website's source language(s).

LanguID™ is the presently preferred language identifier. It currently supports approximately 260 different languages and character encodings. Additionally, LanguID™ has a high sensitivity which allows for greater accuracy and the ability to make estimates with very few characters. Although LanguID™ is the preferred language identifier, any program or utility that performs the same function is acceptable in the method disclosed.

Once the source language(s) is identified, each individual result is sent to a translation engine for translation into the native or source language of the user. The same engine used in the initial steps of the process is preferred for use; however a different translation utility may be used in this step.

Once the results are translated, the results are displayed in both the source language and the language of the user. They are displayed so as to show the website (linked), the name of the website in the source language, and 1-2 sentences of text, also in the source language of the user.

As an additional, although not essential, step to the process, any pages can be fully translated using a translation/search engine, if the user opts to link to the page—either directly or through a “translate” link. Depending on the engine used, the results may be automatically translated and displayed in various formats. If Lexitrieve® is used, the user would highlight text and the engine would then translate.

The previous description has laid out a method and system for an innovative and unique system for multilingual searching and data mining in connected systems such as the Web. The preceding description has been presented only to illustrate and describe exemplary embodiments. It is not intended to be exhaustive or to limit the disclosure to any precise form disclosed. Many modifications and variations are possible in light of the above teaching. It is intended that the scope of the disclosure be defined by the following claims.

What is claimed is:

1- A method for performing a search and retrieval of documents in a computer network comprising:
receiving through an input device, a query in a source language;
receiving specification of at least one target language;
translating said query into each language of the at least one target language to provide translated queries;
performing a contextual search using the translated queries to provide target language search results;
identifying the language of each search result by using a language identification process on each search result;
translating at least part of each target search result into the source language if the target language is not the source language to provide translated search results; and
presenting at least a portion of the translated search results to the user.

2- The method according to claim 1, wherein said at least one target language is pre-set.

3- The method according to claim 1, wherein the computer network is the World Wide Web.

4- The method according to claim 1, wherein a user verifies the query translations prior to searching.

5- The method according to claim 1, wherein the query consists of a phrase or question.

6- The method according to claim 1, wherein the source language is English.

7- The method according to claim 1, wherein more than one language is identified and translated in a single search result.

8- The method according to claim 1, wherein the contextual search is performed by sending the translated query to at least one independently-acting search engine.

9- The method according to claim 1, wherein a search is simultaneously conducted in the source language with the un-translated query and results are presented together.

10- The method according to claim 1, wherein duplicate results are identified and not shown to the user.

11- The method according to claim 1 further comprising:
presenting a web page URL for each translated search result provided to the user;
enabling the user to select one or more search results to display as a translated document, wherein each result is translated according to the identified result language and using the translating utility.
